(19) United States
(12) Patent Application Publication
(10) Pub. No.: US 2024/0012406 A1
(43) Pub. Date: Jan. 11, 2024

(54) FAILURE INDICATION NOTIFICATION SYSTEM

(71) Applicant: Mitsubishi Electric Corporation, Tokyo (JP)

(72) Inventors: Takuma ORIMOTO, Tokyo (JP); Kensuke UEDA, Tokyo (JP); Yuki KOBAYASHI, Tokyo (JP)

(21) Appl. No.: 18/252,396

(22) PCT Filed: Jan. 27, 2021
(86) PCT No.: PCT/JP2021/002839

§ 371 Date: May 10, 2023

(51) Int. Cl. G05B 23/02

(52) U.S. Cl. CPC G05B 23/027; G05B 23/0283

(57) ABSTRACT

A failure indication notification system includes an information collection device and an indication notification device. The information collection device collets device information, attribute information, and service information. The indication notification device includes an indication level computation unit that computes an indication level of failure of a device on the basis of the device information, the attribute information, and prediction model information; a notification level computation unit that computes a notification level on the basis of the attribute information and the service information; a determination unit that determines whether or not the notification about the indication of the device failure is to be provided on the basis of comparison between the indication level and the notification level; and a notification unit that notifies an outside of the failure indication notification system of indication information indicating the indication of the device failure.

### CROSS-REFERENCE TO RELATED APPLICATION

This application is a U.S. National Stage Application of International Application No. PCT/JP2021/002839 filed on Jan. 27, 2021, the contents of which are incorporated herein by reference.

### TECHNICAL FIELD

The present disclosure relates to a failure indication notification system that provides a notification about an indication of device failure.

### BACKGROUND

A home appliance inspection system that has been proposed makes a low-priced inspection of a home appliance with no special diagnostic means installed on the home appliance and provides a service center with a notification about repair action when the appliance fails (refer to, for example, Patent Literature 1). There is also a proposed technique that prevents trouble, such as a sudden situation that calls for a repair, by predicting failure of an air conditioner. The technique detects an indication of the device failure on the basis of device operation information and a degree of deviation of operating characteristic values from a design value as an ideal value (refer to, for example, Patent Literature 2).

### PATENT LITERATURES

Patent Literature 1: Japanese Patent Application Laid-open No. 2007-305145
Patent Literature 2: Japanese Patent Application Laid-open No. 2019-80195

A problem with the conventional technique is that even if a notification about the failure indication detected on the basis of, for example, air conditioner operation information is provided, the notification becomes a useless notification in cases where, for example, immediate action is not possible during a busy service period. The above-mentioned operation information is an example included in device information. Another problem with the conventional technique is that the failure diagnosis or the failure indication detection that is based on the device information alone requires much device information, causing increased data communication costs. Yet another problem with the conventional technique is that when the operating characteristic values do not deviate from the design value, the failure indication cannot be detected, resulting in a need for action to be taken for the device failure that is sudden.

### SUMMARY

The present disclosure has been made in view of the above, and an object of the present disclosure is to obtain a failure indication notification system that accurately detects an indication of device failure with fewer data and provides a notification about the indication of the device failure.

To solve the aforementioned problem and achieve the object, a failure indication notification system according to the present disclosure includes: an information collection device that collects information to be used in notification of an indication of failure of a device; and an indication notification device that provides a notification about an indication of the device failure. The information collection device includes: a device information collection unit that collects device information including device operation information, an attribute information collection unit that collects attribute information including a part or all of customer information, property information, and house information, and a service information collection unit that collects service information to be provided for a service person who will handle failure, the service information including information indicating some or all of a preferred date of failure handling, arrangement of failure-related parts, and a failure-related parts count. The indication notification device includes: an indication level computation unit that obtains prediction model information indicating a degradation model that predicts degradation of a part included in the device and computes, on a basis of the device information and the attribute information that the information collection device has collected and the prediction model information obtained, an indication level of the device failure, a notification level computation unit that computes, on a basis of the attribute information and the service information that the information collection device has collected, a notification level to be used in determination of whether or not the notification about an indication of the device failure is to be provided, a determination unit that determines whether or not the notification about an indication of the device failure is to be provided on a basis of comparison between the indication level computed by the indication level computation unit and the notification level computed by the notification level computation unit, and a notification unit that notifies, when the determination unit has determined that the notification about an indication of the device failure be provided, an outside of the failure indication notification system of indication information indicating an indication of the device failure.

The failure indication notification system according to the present disclosure has effects of accurately detecting the indication of the device failure with fewer data and providing the notification about the indication of the device failure.

### BRIEF DESCRIPTION OF DRAWINGS

FIG. 1 is a diagram illustrating a configuration of a failure indication notification system according to a first embodiment.

FIG. 2 is a flowchart illustrating an operational procedure of an information collection device included in the failure indication notification system according to the first embodiment.

FIG. 3 is a flowchart illustrating an operational procedure of an indication notification device included in the failure indication notification system according to the first embodiment.

FIG. 4 is a diagram illustrating a configuration of a failure indication notification system according to a second embodiment.

FIG. 5 is a flowchart illustrating an operational procedure of a service coordination device included in the failure indication notification system according to the second embodiment.

FIG. 6 is a diagram illustrating a configuration of a failure indication notification system according to a third embodiment.

FIG. 7 is a flowchart illustrating an operational procedure of the failure indication notification system according to the third embodiment.

FIG. 8 is a diagram illustrating a processor in cases where the processor is used to implement at least some of a device information collection unit, an attribute information collection unit, and a service information collection unit that the information collection device of the failure indication notification system according to the first embodiment includes.

FIG. 9 is a diagram illustrating processing circuitry in cases where the processing circuitry is used to implement at least some of the device information collection unit, the attribute information collection unit, and the service information collection unit that the information collection device of the failure indication notification system according to the first embodiment includes.

### DETAILED DESCRIPTION

With reference to the drawings, a detailed description is hereinafter provided of failure indication notification systems according to embodiments.

### First Embodiment

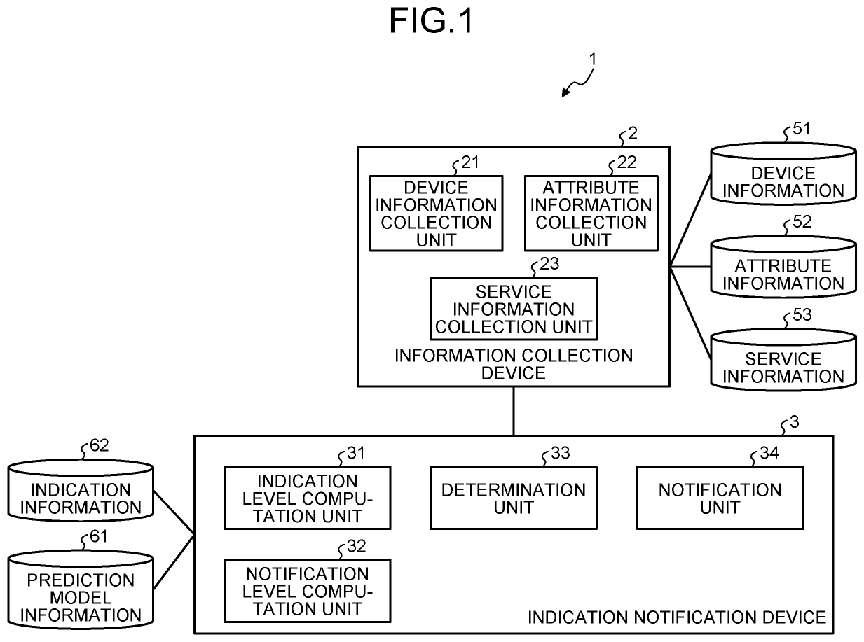

FIG. 1 is a diagram illustrating a configuration of a failure indication notification system 1 according to a first embodiment. The failure indication notification system 1 includes an information collection device 2 that collects information to be used in notification of an indication of failure of a device and an indication notification device 3 that provides a notification about the indication of the device failure. The information collection device 2 is connected to the indication notification device 3.

The information collection device 2 includes a device information collection unit 21 that collects device information 51 and an attribute information collection unit 22 that collects attribute information 52. The device information 51 includes device operation information. The attribute information 52 includes part or all of customer information, property information, and house information. The information collection device 2 further includes a service information collection unit 23 that collects service information 53 to be provided for a service person who will handle the failure. The service information 53 includes information that indicates some or all of a preferred date of failure handling, arrangement of failure-related parts, and a failure-related parts count.

The indication notification device 3 includes an indication level computation unit 31 that obtains prediction model information 61 and computes, on the basis of the device information 51 and the attribute information 52 that the information collection device 2 has collected and the obtained prediction model information 61, an indication level of the device failure. The prediction model information 61 indicates a degradation model that predicts degradation of parts of the device. The indication level computation unit 31 is a constituent element that quantifies a priority level of the notification about the device failure. The indication notification device 3 further includes a notification level computation unit 32 that computes, on the basis of the attribute information 52 and the service information 53 that the information collection device 2 has collected, a notification level to be used in determination of whether or not the notification about the indication of the device failure is to be provided.

The indication notification device 3 further includes a determination unit 33 that determines whether or not the notification about the indication of the device failure is to be provided on the basis of comparison between the indication level computed by the indication level computation unit 31 and the notification level computed by the notification level computation unit 32. The indication notification device 3 further includes a notification unit 34 that notifies, when the determination unit 33 has determined that the notification about the indication of the device failure be provided, an outside of the failure indication notification system 1 of indication information 62 indicating the indication of the device failure.

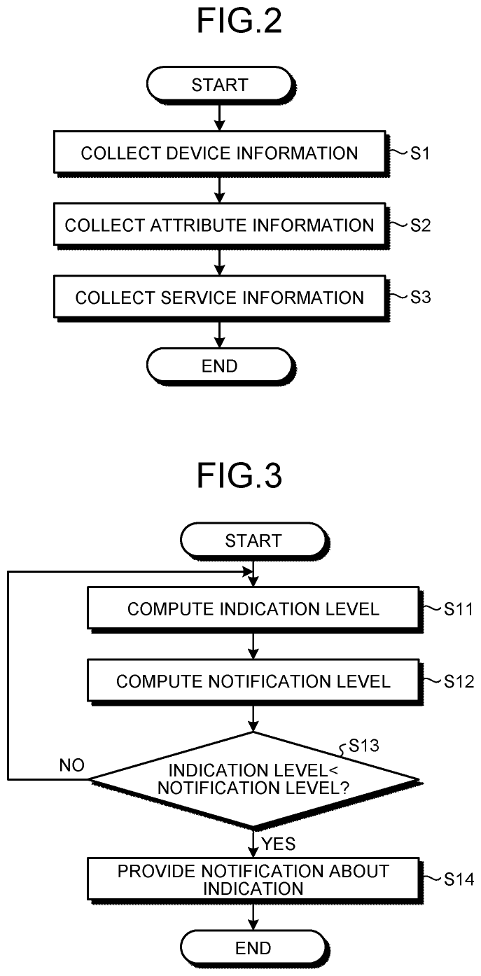

FIG. 2 is a flowchart illustrating an operational procedure of the information collection device 2 included in the failure indication notification system 1 according to the first embodiment. The device information collection unit 21 collects the device information 51, which includes the device operation information (S1). The attribute information collection unit 22 collects the attribute information 52, which includes the part or all of the customer information, property information, and house information (S2). The service information collection unit 23 collects the service information 53 to be provided for the service person who will handle the failure (S3).

As described above, the service information 53 includes the information that indicates some or all of the preferred date of the failure handling, the arrangement of the failure-related parts, and the failure-related parts count.

FIG. 3 is a flowchart illustrating an operational procedure of the indication notification device 3 included in the failure indication notification system 1 according to the first embodiment. The indication level computation unit 31 obtains the prediction model information 61, which indicates the degradation model predictive of the degradation of the parts of the device, and computes the indication level of the device failure on the basis of the device information 51 and the attribute information 52 that the information collection device 2 has collected and the obtained prediction model information 61 (S11).

On the basis of the attribute information 52 and the service information 53 that the information collection device 2 has collected, the notification level computation unit 32 computes the notification level to be used in the determination of whether or not the notification about the indication of the device failure is to be provided (S12). On the basis of the comparison between the indication level computed by the indication level computation unit 31 and the notification level computed by the notification level computation unit 32, the determination unit 33 determines whether or not the notification about the indication of the device failure is to be provided (S13). Specifically, the determination unit 33 judges at step S13 whether or not the computed indication level is lower than the computed notification level. If the determination unit 33 judges that the indication level is lower than the computed notification level (Yes at S13), the determination unit 33 determines that the notification about the indication of the device failure be provided. If the determination unit 33 determines that the notification about the indication of the device failure be provided (Yes at S13), the notification unit 34 notifies the outside of the failure indication notification system 1 of the indication information 62, which indicates the indication of the device failure (S14).

If the determination unit 33 judges that the indication level is higher than or equal to the notification level (No at S13), the determination unit 33 determines that the notification not be provided about the indication of the device failure. If the determination unit 33 determines that the notification not be provided about the indication of the device failure (No at S13), the indication notification device 3 moves to step S11 in the operation.

For example, in cases where a user has set the failure indication to be notified of one month before the failure presumedly occurs, with the failure predicted to occur six months later, the indication level computation unit 31 computes the indication level “3”, and the notification level computation unit 32 computes the notification level “1”. Above-mentioned “3” denotes a middle level, and above-mentioned “1” denotes a relatively low level. Thus the notification about the failure indication that is provided by a conventional one is not provided by the failure indication notification system 1. When, for example, service availability goes beyond a busy period and causes the notification level to be lowered significantly from “3”, the failure indication notification system 1 provides the notification.

As described above, the failure indication notification system 1 according to the first embodiment determines whether or not to provide the notification about the indication of the device failure on the basis of the device information 51, the attribute information 52, the service information 53, and the prediction model information 61 and notifies the outside of the failure indication notification system 1 of the indication information 62, which indicates the indication of the device failure, upon determining to provide the notification about the indication of the device failure. Therefore, the failure indication notification system 1 is capable of accurately detecting the indication of the device failure with fewer data and providing the notification about the indication of the device failure. Moreover, the failure indication notification system 1 is capable of providing the notification about the indication of the device failure with timing that is appropriate from viewpoints of the device user, a device owner, and the repairer. Furthermore, the failure indication notification system 1 provides for cost-saving detection of the indication of the device failure and is capable of meeting a demand such that the indication of the failure needs to be notified of as early as possible since the device's constant operation is requisite and reducing or preventing, for example, useless notifications that, if provided, result in cases where service is unavailable for the failure. Therefore, the failure indication notification system 1 has improved extensibility and improved efficiency with respect to the notification of the indication of the device failure.

The model indicated by the prediction model information 61 may be a model that calculates the indication of the failure on the basis of either physical phenomena or domain knowledge or both, or a model that calculates the indication of the failure on the basis of past data. The model indicated by the prediction model information 61 may be a model that is created from the physical phenomena and the domain knowledge and then has parts that cannot be ascertained from the physical phenomena and the domain knowledge compensated on the basis of the past data to calculate the indication of the failure.

The information collection device 2 may further collect information about usage of a second device of the customer that is different from the above device, information relating to replacement parts distribution, and information about action of the service person. In cases where the information collection device 2 further collects the information about the usage of the second device, the information relating to replacement parts distribution, and the information about the action of the service person, the indication notification device 3 may operate as follows. The indication notification device 3 may further use the information about the usage of the second device, the information relating to replacement parts distribution, and the information about the action of the service person that the information collection device 2 has collected in computing the indication level of the device failure, determine whether or not to provide the notification about the indication of the device failure on the basis of available dates of a service company, information indicating a parts inventory, and user desirability of notification, and provide the notification of the indication information 62 upon determining to provide the notification about the indication of the device failure.

The indication notification device 3 may notify the outside of the failure indication notification system 1 of the indication information 62, which indicates the indication of the device failure, behind schedule or ahead of schedule to avoid the busy service period.

The attribute information 52 may further include some or all of an area, equipment, and family structure. The service information 53 may further include information about a schedule of the repairer.

### Second Embodiment

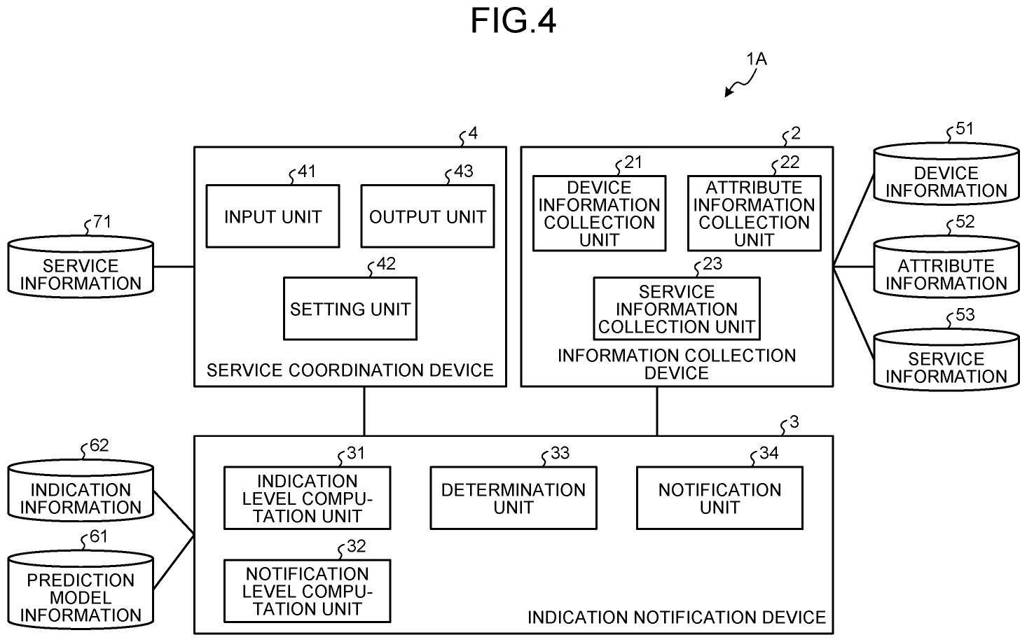

FIG. 4 is a diagram illustrating a configuration of a failure indication notification system 1A according to a second embodiment. The failure indication notification system 1A includes the information collection device 2 and the indication notification device 3 that the failure indication notification system 1 according to the first embodiment includes. The failure indication notification system 1A further includes a service coordination device 4. The service coordination device 4 is connected to the indication notification device 3. In the second embodiment, a description is provided mainly of difference from the first embodiment.

The service coordination device 4 includes an input unit 41 that proposes, on the basis of the indication information 62 that the indication notification device 3 has notified of and service information 71, plural services including some or all of a location of part replacement, costs associated with the replacement, and a service schedule. The service coordination device 4 further includes a setting unit 42 for the device user or owner to select one or more of the proposed plural services. The service coordination device 4 further includes an output unit 43 that notifies, for example, a service company of information about the service(s).

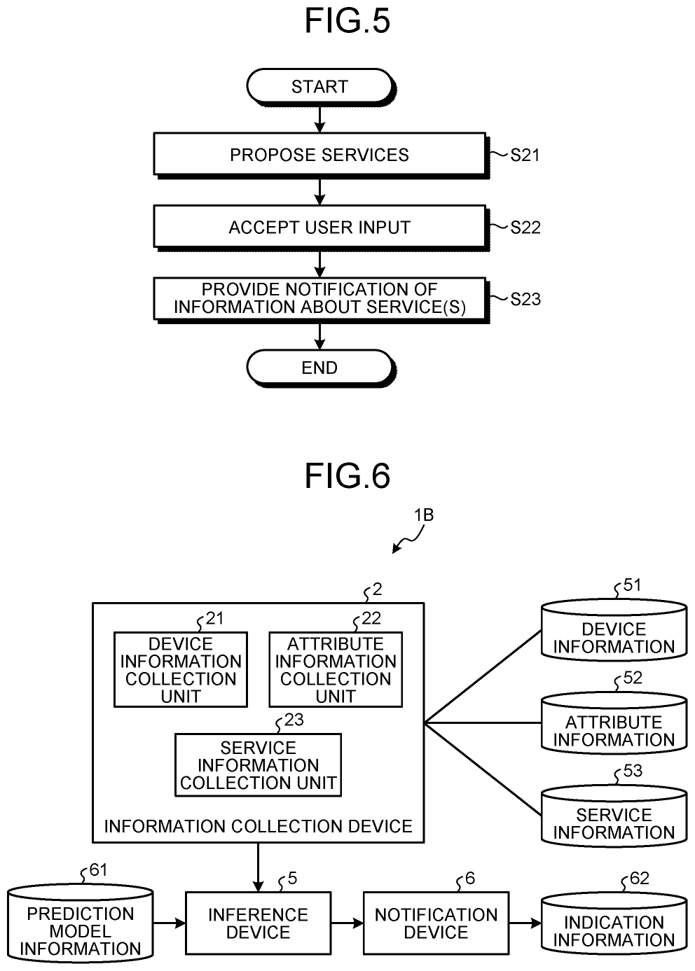

FIG. 5 is a flowchart illustrating an operational procedure of the service coordination device 4 included in the failure indication notification system 1A according to the second embodiment. On the basis of the indication information 62 that the indication notification device 3 has notified of and the service information 71, the input unit 41 proposes the plural services, which include some or all of the location of part replacement, the costs associated with the replacement, and the service schedule (S21). The device user or owner selects the one or more of the proposed plural services, and the setting unit 42 accepts the selected service(s) (S22). In FIG. 5, the activity of step S22 is phrased as “ACCEPT USER INPUT”. The output unit 43 notifies, for example, the service company of the information about the service(s) (S23). The output unit 43 may provide the notification using e-mail, mail, telephone, or online chat.

The service coordination device 4 may be a device that enables the user who has been notified of the indication information 62 to adjust contents of a part replacement service and an available service date.

### Third Embodiment

FIG. 6 is a diagram illustrating a configuration of a failure indication notification system 1B according to a third embodiment. The failure indication notification system 1B includes the information collection device 2 that the failure indication notification system 1 according to the first embodiment includes. In the third embodiment, the term “collect” used in the first embodiment is replaced with the term “obtain” in some parts. The failure indication notification system 1B further includes an inference device 5 and a notification device 6. In the third embodiment, a description is provided mainly of difference from the first embodiment.

The inference device 5 obtains the prediction model information 61, which indicates the degradation model predictive of the degradation of the parts of the device, and using the prediction model information 61, infers a determination result that determines whether or not a notification about an indication of device failure is to be provided. Specifically, in inferring the determination result, which determines whether or not the notification about the indication of the device failure is to be provided, with the prediction model information 61, the inference device 5 obtains the prediction model information 61 and inputs the device information 51, the attribute information 52, and the service information 53 that the information collection device 2 has obtained into the prediction model information 61.

In other words, by inputting into the prediction model information 61 the device information 51, the attribute information 52, and the service information 53 that the information collection device 2 has obtained, the inference device 5 can output the determination result inferred from the device information 51, the attribute information 52, and the service information 53. If the determination result inferred by the inference device 5 indicates that the notification about the indication of the device failure is to be provided, the notification device 6 notifies an outside of the failure indication notification system 1B of the indication information 62, which indicates the indication of the device failure.

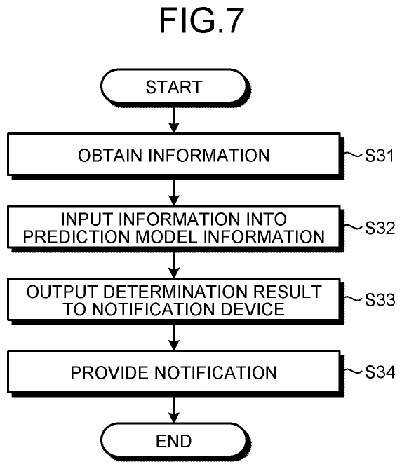

FIG. 7 is a flowchart illustrating an operational procedure of the failure indication notification system 1B according to the third embodiment. The information collection device 2 obtains the device information 51, the attribute information 52, and the service information 53 (S31). The inference device 5 inputs the device information 51, the attribute information 52, and the service information 53 that the information collection device 2 has obtained into the prediction model information 61 to obtain the determination result (S32). The inference device 5 outputs the determination result obtained with the prediction model information 61 to the notification device 6 (S33).

If the determination result inferred by the inference device 5 indicates that the notification about the indication of the device failure is to be provided, the notification device 6 notifies the outside of the failure indication notification system 1B of the indication information 62, which indicates the indication of the device failure (S34). If the determination result inferred by the inference device 5 indicates that the notification about the indication of the device failure is not to be provided, the notification device 6 does not notify the outside of the failure indication notification system 1B of the indication information 62.

As described above, the failure indication notification system 1B according to the third embodiment infers the determination result that determines whether or not the notification about the indication of the device failure is to be provided on the basis of the device information 51, the attribute information 52, the service information 53, and the prediction model information 61 and notifies the outside of the failure indication notification system 1B of the indication information 62, which indicates the indication of the device failure, upon inferring the determination result indicating that the notification about the indication of the device failure is to be provided. Therefore, the failure indication notification system 1B is capable of accurately detecting the indication of the device failure with fewer data and providing the notification about the indication of the device failure. Moreover, the failure indication notification system 1B is capable of providing the notification about the indication of the device failure with timing that is appropriate from viewpoints of a device user, a device owner, and a repairer.

The information collection device 2 may further collect information about usage of a second device of the customer that is different from the above device, information relating to replacement parts distribution, and information about action of the service person. In that case, using the information about the usage of the second device, the information relating to replacement parts distribution, and the information about the action of the service person that the information collection device 2 has collected and also available dates of a service company, information indicating a parts inventory, and user desirability of notification, the inference device 5 may infer the determination result that determines whether or not the notification about the indication of the device failure is to be provided.

The inference device 5 may be connected to the notification device 6 via a communication network. The notification device 6 may be inside the inference device 5.

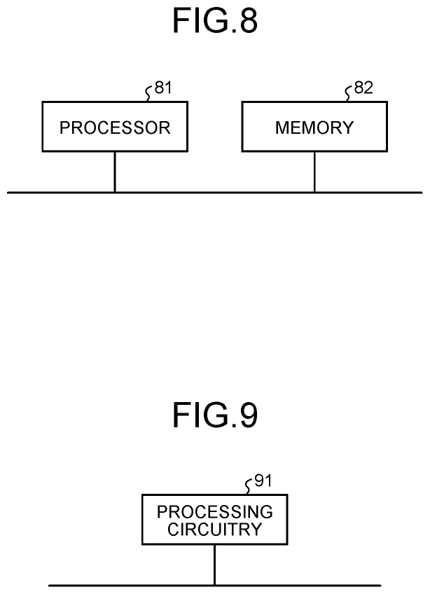

FIG. 8 is a diagram illustrating a processor 81 in cases where the processor 81 is used to implement at least some of the device information collection unit 21, the attribute information collection unit 22, and the service information collection unit 23 that the information collection device 2 of the failure indication notification system 1 according to the first embodiment includes. In other words, the processor 81 that executes stored programs in a memory 82 may be used to implement the functions of the at least some of the device information collection unit 21, the attribute information collection unit 22, and the service information collection unit 23.

The processor 81 is a central processing unit (CPU), a processing unit, an arithmetic unit, a microprocessor, or a digital signal processor (DSP). The memory 82, too, is illustrated in FIG. 8.

In cases where the functions of the at least some of the device information collection unit 21, the attribute information collection unit 22, and the service information collection unit 23 are implemented with the processor 81, these functions are implemented with the processor 81 and software, firmware, or a combination of software and firmware. The software or the firmware is described as programs and is stored in the memory 82. The processor 81 reads and executes the programs stored in the memory 82 to implement the functions of the at least some of the device information collection unit 21, the attribute information collection unit 22, and the service information collection unit 23.

In cases where the functions of the at least some of the device information collection unit 21, the attribute information collection unit 22, and the service information collection unit 23 are implemented with the processor 81, the memory 82 is included in the information collection device 2 of the failure indication notification system 1 to store the programs with which at least some of the steps for the device information collection unit 21, the attribute information collection unit 22, and the service information collection unit 23 are eventually executed. The programs stored in the memory 82 can be said to cause a computer to perform the at least some of the device information collection unit 21, the attribute information collection unit 22, and the service information collection unit 23.

The memory 82 is, for example, a nonvolatile or volatile semiconductor memory such as a random-access memory (RAM), a read-only memory (ROM), a flash memory, an erasable programmable read-only memory (EPROM), or an electrically erasable programmable read-only memory (EEPROM) (registered trademark), a magnetic disk, a flexible disk, an optical disk, a compact disk, a mini disk, a digital versatile disk (DVD), or the like.

FIG. 9 is a diagram illustrating processing circuitry 91 in cases where the processing circuitry 91 is used to implement at least some of the device information collection unit 21, the attribute information collection unit 22, and the service information collection unit 23 that the information collection device 2 of the failure indication notification system 1 according to the first embodiment includes. In other words, the at least some of the device information collection unit 21, the attribute information collection unit 22, and the service information collection unit 23 may be implemented with the processing circuitry 91.

The processing circuitry 91 is dedicated hardware. The processing circuitry 91 is, for example, a single circuit, a composite circuit, a programmed processor, a parallel programmed processor, an application-specific integrated circuit (ASIC), a field-programmable gate array (FPGA), or a combination of these.

Some of the device information collection unit 21, the attribute information collection unit 22, and the service information collection unit 23 may be dedicated hardware separate from the other(s).

Some of the plural functions of the device information collection unit 21, the attribute information collection unit 22, and the service information collection unit 23 may be implemented with software or firmware, while the remaining function(s) may be implemented with dedicated hardware. As described above, the plural functions of the device information collection unit 21, the attribute information collection unit 22, and the service information collection unit 23 are implementable with the hardware, the software, the firmware or the combination of these.

At least some of the indication level computation unit 31, the notification level computation unit 32, the determination unit 33, and the notification unit 34 that the indication notification device 3 of the failure indication notification system 1 according to the first embodiment includes may be implemented with a processor or processing circuitry. The processor is the same as the above processor 81. The processing circuitry is the same as the above processing circuitry 91.

At least some of the input unit 41, the setting unit 42, and the output unit 43 that the service coordination device 4 of the failure indication notification system 1A according to the second embodiment includes may be implemented with a processor or processing circuitry. The processor is the same as the above processor 81. The processing circuitry is the same as the above processing circuitry 91.

At least part of the inference device 5 of the failure indication notification system 1B according to the third embodiment may be implemented with a processor or processing circuitry. The processor is the same as the above processor 81. The processing circuitry is the same as the above processing circuitry 91.

At least part of the notification device 6 of the failure indication notification system 1B according to the third embodiment may be implemented with a processor or processing circuitry. The processor is the same as the above processor 81. The processing circuitry is the same as the above processing circuitry 91.

The above configurations illustrated in the embodiments are illustrative, can be combined with other techniques that are publicly known, and can be partly omitted or changed without departing from the gist. The embodiments can be combined together.

1. A failure indication notification system comprising:
an information collection device to collect information to be used in notification of an indication of failure of a device; and
an indication notification device to provide a notification about an indication of the device failure, wherein
the information collection device includes
a device information collecting circuitry to collect device information including device operation information,
an attribute information collecting circuitry to collect attribute information including a part or all of customer information, property information, and house information, and
a service information collecting circuitry to collect service information to be provided for a service person who will handle failure, the service information including information indicating some or all of a preferred date of failure handling, arrangement of failure-related parts, and a failure-related parts count, and
the indication notification device includes
an indication level computing circuitry to obtain prediction model information indicating a degradation model that predicts degradation of a part included in the device and compute, on a basis of the device information and the attribute information that the information collection device has collected and the prediction model information obtained, an indication level of the device failure,
a notification level computing circuitry to compute, on a basis of the attribute information and the service information that the information collection device has collected, a notification level to be used in determination of whether or not the notification about an indication of the device failure is to be provided,
a determining circuitry to determine whether or not the notification about an indication of the device failure is to be provided on a basis of comparison between the indication level computed by the indication level computing circuitry and the notification level computed by the notification level computing circuitry, and
a notifying circuitry to notify, when the determining circuitry has determined that the notification about an indication of the device failure be provided, an outside of the failure indication notification system of indication information indicating an indication of the device failure.

2. The failure indication notification system according to claim 1, wherein
the information collection device further collects information about usage of a customer's second device different from the device, information relating to replacement parts distribution, and information about action of the service person.

3. The failure indication notification system according to claim 2, wherein
the indication notification device
further uses the information about the usage of the second device, the information relating to the replacement parts distribution, and the information about the action of the service person that the information collection device has collected in computing the indication level of the device failure, and
determines whether or not to provide the notification about an indication of the device failure on a basis of an available date of a service company, information indicating a parts inventory, and user desirability of notification, and provides the notification of the indication information upon determining to provide the notification about the indication of the device failure.

4. The failure indication notification system according to claim 1, further comprising
a service coordination device to enable a user who has been notified of the indication information to adjust a content of a part replacement service and an available service date.

5. The failure indication notification system according to claim 3, further comprising
a service coordination device to enable a user who has been notified of the indication information to adjust a content of a part replacement service and an available service date.

6. A failure indication notification system comprising:
an information collection device to obtain information to be used in notification of an indication of failure of a device;
an inference device to infer a determination result that determines whether or not a notification about an indication of the device failure is to be provided; and
a notification device to notify an outside of the failure indication notification system of indication information indicating an indication of the device failure, wherein
the information collection device obtains device information, attribute information, and service information, the device information including device operation information, the attribute information including a part or all of customer information, property information, and house information, the service information to be provided for a service person who will handle failure and including information indicating some or all of a preferred date of failure handling, arrangement of failure-related parts, and a failure-related parts count,
the inference device inputs the device information, the attribute information, and the service information that the information collection device has obtained into prediction model information in inferring, with the prediction model information, a determination result that determines whether or not the notification about an indication of the device failure is to be provided, the prediction model information indicating a degradation model that predicts degradation of a part included in the device, and
the notification device notifies the outside of the failure indication notification system of indication information that indicates an indication of the device failure when a determination result inferred by the inference device indicates that the notification about an indication of the device failure is to be provided.

7. The failure indication notification system according to claim 6, wherein
the information collection device further obtains information about usage of a customer's second device different from the device, information relating to replacement parts distribution, and information about action of the service person, and
further using the information about the usage of the second device, the information relating to the replacement parts distribution, and the information about the action of the service person that the information collection device has obtained and also an available date of a service company, information indicating a parts inventory, and user desirability of notification, the inference device infers the determination result that determines whether or not the notification about an indication of the device failure is to be provided.
